(19) United States
(12) Patent Application Publication
(10) Pub. No.: US 2017/0330053 A1
(43) Pub. Date: Nov. 16, 2017

(54) COLOR NIGHT VISION SYSTEM AND OPERATION METHOD THEREOF

(71) Applicant: Center for Integrated Smart Sensors Foundation, Daejeon (KR)

(72) Inventors: Ki Yeong PARK, Daejeon (KR); Young Ki KIM, Daejeon (KR)

(21) Appl. No.: 15/592,989

(22) Filed: May 11, 2017

(30) Foreign Application Priority Data
May 11, 2016 (KR) 10-2016-0057605

(51) Int. Cl. G06K 9/46; H04N 5/33; G06T 5/00; G06T 5/40; H04N 7/18; G06T 11/60

(52) U.S. Cl. CPC G06K 9/4661; H04N 7/183; H04N 5/332; G06T 11/60; G06T 5/002; G06K 9/4652; G06T 5/40; G06T 5/009; G06T 2207/10024; G06T 2207/10048

(57) ABSTRACT

Disclosed is a color night vision system including a single-4-color image sensor configured to acquire a red, green, blue (RGB) image and an infrared (IR) image by processing RGB light signals and an IR light signal for each wavelength; and a processor configured to determine an exposure state of the RGB image by analyzing a brightness distribution of the RGB image, to decide at least one of an exposure compensation level of the RGB image, a denoising level of the RGB image, or a synthesis ratio between the RGB image and the IR image based on the determination result, and to create an output image based on the decision result that is made using the RGB image and the IR image.

### CROSS-REFERENCE TO RELATED APPLICATION

This application claims the priority benefit of Korean Patent Application No. 10-2016-0057605, filed on May 11, 2016, in the Korean Intellectual Property Office, the disclosure of which is incorporated herein by reference.

### BACKGROUND

### 1. Field of the Invention

The following example embodiments relate to a color night vision system and an operation method of the color night vision system, and more particularly, to technology using a red, green, blue (RGB) image and an infrared (IR) image to acquire an identifiable image in a low luminance environment.

### 2. Description of the Related Art

A night vision is generally used to acquire an identifiable image in a low luminance environment in an automotive night vision system helping drive at night and in a surveillance camera system.

An automotive night vision system is classified into a passive system which acquires an image using a thermal imaging camera without using a separate illumination device and an active system which acquires an image using an infrared (IR) camera by emitting near IR illumination up to a distance from 150 to 200 m using an IR headlight, etc., separate from a visible headlight.

The passive system may secure a field of view up to about 300 m ahead without using a separate illumination device, however, has a relatively large sensor size, provides a relatively low image resolution, and does not properly operate in a hot weather condition. On the other hand, the active system provides the relatively short visibility of 150 to 200 m compared to the passive system and does not provide an excellent image when it is foggy or rainy, however, has a relatively small sensor size and acquires a relatively high resolution image. Further, the active system may acquire an excellent image from an inorganic substance and may well operate even in a hot weather condition.

In the case of a surveillance camera, a general charge-coupled device (CCD) or complementary metal-oxide semiconductor (CMOS) color sensor has a sufficient sensitivity for IR rays. Thus, used is a method that may acquire a conventional color image by providing an IR cutoff filter movable by a mechanical shutter device to be in front of the sensor during the day or in an environment with a sufficient illumination, and may acquire an IR image by turning on an IR illumination and by removing the IR cutoff filter from the front of the sensor when an illumination becomes insufficient. Also, introduced is a system that may acquire a high quality color image as one acquirable during the day, even in a low luminance environment, such as night, using a highly sensitive color sensor. However, such color night vision systems need to use an expensive large-diameter lens.

Accordingly, developed is technology for acquiring a color night vision image by simultaneously acquiring a color image and a monochromic IR image using a color sensor and a near infrared (NIR) sensor or a far-infrared (FIR) sensor provided to be independent from each other, and by synthesizing the color image and the monochromic IR image. Synthesizing the color image and the IR image may use a method known in the image processing field, for example, “Colouring the near-infrared,” prepared by C. Fredembach and S. Suesstrunk, in Proc. IS&T/SID 16th Color Imaging Conference, pp. 176-182, 200”. Technology for synthesizing a color image including red, green, blue (RGB), three color channels, and an IR image of a single channel acquires a synthesized image by converting a color space of the color image, by decomposing the converted color space into a luminance (luma) component and a chrominance (chroma) component, and by replacing the luminance component with an IR channel or by weighted-averaging the luminance component and the IR channel.

However, to enable the synthesis, a parallax needs to be absent between two images. When a color image and an IR image are captured using two sensors, respectively, such as two eyes of a human being, a parallax is present between the two images output from the two sensors. Thus, when synthesizing the two images, a phenomenon that objects appear to overlap may occur. Also, the two images need to be properly exposed. When an exposure of either the color image or the IR image is low due to a dark environment, an image with a relatively low signal-to-noise ratio (SNR) is acquired. Accordingly, when the color image and the IR image are synthesized in this situation, that is, when the color image and the IR image are synthesized without performing a separate denoising, an acquired image includes relatively large noise.

For example, referring to JP 4363207 B2 that is the patent of Sumimoto Electric Ind. Ltd., since a parallax is present between a plurality of images output from a plurality of imaging devices mounted to a vehicle, a phenomenon that the images appear to overlap occurs when the images are synthesized during a process of acquiring a color image by weighted-averaging and synthesizing the plurality of images output from the plurality of imaging devices based on brightness information associated with a surrounding of a vehicle or a luminance distribution of image data.

Accordingly, the following example embodiments propose color night vision technology for preventing a parallax from being present between an RGB image and an IR image by processing RGB light signals and an IR light signal using a single-4-color image sensor.

### SUMMARY

At least one example embodiment provides a color night vision system that may prevent a parallax from being present between a red, green, blue (RGB) image and an infrared (IR) image by processing RGB light signals and an IR light signal using a single-4-color image sensor, and an operation method of the color night vision system.

At least one example embodiment also provides a color night vision system that may selectively output at least one of an RGB image, an IR image, or an synthetic image of the RGB image and the IR image based on a brightness distribution of the RGB image acquired from a single-4-color image sensor, and an operation method of the color night vision system.

At least one example embodiment also provides a color night vision system that may perform an exposure compensation and a denoising on an RGB image and may synthesize the RGB image and an IR image by deciding an exposure compensation level of the RGB image, a denoising level of the RGB image, and a synthesis ratio between the RGB image and the IR image based on a brightness distribution of the RGB image, and an operation method of the color night vision system.

According to an aspect of at least one example embodiment, there is provided a color night vision system including a single-4-color image sensor configured to acquire an RGB image and an IR image by processing RGB light signals and an IR light signal for each wavelength; and a processor configured to determine an exposure state of the RGB image by analyzing a brightness distribution of the RGB image, to decide at least one of an exposure compensation level of the RGB image, a denoising level of the RGB image, or a synthesis ratio between the RGB image and the IR image based on the determination result, and to create an output image based on the decision result that is made using the RGB image and the IR image.

The processor may be configured to selectively use at least one of the RGB image, the IR image, or a synthetic image of the RGB image and the IR image as the output image.

The processor may be configured to use the RGB image as the output image in response to the exposure state of the RGB image being determined as a normal state.

The processor may be configured to perform an exposure compensation on the RGB image based on the decided exposure compensation level in response to the exposure state of the RGB image being determined as an insufficient state and the exposure state of the RGB image being recoverable through an exposure compensation, and to use the exposure-compensated RGB image as the output image.

The processor may be configured to synthesize the RGB image and the IR image based on the decided synthesis ratio in response to the exposure state of the RGB image being determined as an insufficient state, the exposure state of the RGB image being irrecoverable through an exposure compensation, and partial information for creating the output image remaining in the RGB image, and to use the synthetic image acquired through the synthesis as the output image.

The processor may be configured to synthesize the RGB image and the IR image by weighted-averaging the RGB image and the IR image based on the decided synthesis ratio.

The processor may be configured to use the IR image as the output image in response to the exposure state of the RGB image being determined as a dark state.

The processor may be configured to perform an exposure compensation and a denoising on the RGB image in response to the RGB image being acquired from the single-4-color image sensor in a low luminance environment.

According to an aspect of at least one example embodiment, there is provided an operation method of a color night vision system, the method including acquiring, using a single-4-color image sensor, an RGB image and an IR image by processing RGB light signals and an IR light signal for each wavelength; determining, using a processor, an exposure state of the RGB image by analyzing a brightness distribution of the RGB image; deciding, using the processor, at least one of an exposure compensation level of the RGB image, a denoising level of the RGB image, or a synthesis ratio between the RGB image and the IR image based on the determination result; and creating, using the processor, an output image based on the decision result that is made using the RGB image and the IR image.

The creating of the output image may include selectively using at least one of the RGB image, the IR image, or a synthetic image of the RGB image and the IR image as the output image.

The selectively using may include using the RGB image as the output image in response to the exposure state of the RGB image being determined as a normal state.

The selectively using may include performing an exposure compensation on the RGB image based on the decided exposure compensation level in response to the exposure state of the RGB image being determined as an insufficient state and the exposure state of the RGB image being recoverable through an exposure compensation; and using the exposure-compensated RGB image as the output image.

The selectively using may include synthesizing the RGB image and the IR image based on the decided synthesis ratio in response to the exposure state of the RGB image being determined as an insufficient state, the exposure state of the RGB image being irrecoverable through an exposure compensation, and partial information for creating the output image remaining in the RGB image; and using the synthetic image acquired through the synthesis as the output image.

The selectively using may include using the IR image as the output image in response to the exposure state of the RGB image being determined as a dark state.

According to example embodiments, there may be provided a color night vision system that may prevent a parallax from being present between an RGB image and an IR image by processing RGB light signals and an IR light signal using a single-4-color image sensor, and an operation method of the color night vision system.

Also, according to example embodiments, there may be provided a color night vision system that may selectively output at least one of an RGB image, an IR image, or an synthetic image of the RGB image and the IR image based on a brightness distribution of the RGB image acquired from a single-4-color image sensor, and an operation method of the color night vision system.

Also, according to example embodiments, there may be provided a color night vision system that may output an RGB image during the day or an environment with a sufficient illumination, may output an IR image in a dark state in which RGB light signals are barely present, and may output a synthetic image of the RGB image and the IR image in a state in which a portion of RGB light signals are present regardless of a low luminance environment, and an operation method of the color night vision system.

Also, according to example embodiments, there may be provided a color night vision system that may perform an exposure compensation and a denoising on an RGB image and may synthesize the RGB image and an IR image by deciding an exposure compensation level of the RGB image, a denoising level of the RGB image, and a synthesis ratio between the RGB image and the IR image based on a brightness distribution of the RGB image, and an operation method of the color night vision system.

Also, according to example embodiments, there may be provided a color night vision system that may prevent noise of an RGB image from being included in a synthetic image of the RGB image and an IR image in a low luminance environment by correcting a color contamination between RGB light signals and an IR light signal and by deciding a denoising level of the RGB image and a synthesis ratio between the RGB image and the IR image using a single-4-color image sensor, and an operation method of the color night vision system.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of describing an operation method of a color night vision system according to an example embodiment;

FIG. 2 illustrates an example of describing an operation method of a color night vision system in a low luminance environment of FIG. 1 in which a portion of red, green, blue (RGB) light signals are present;

FIG. 3 is a flowchart illustrating an operation method of a color night vision system according to an example embodiment;

FIG. 4 is a flowchart illustrating an operation of creating an output image of FIG. 3; and

FIG. 5 is a block diagram illustrating a color night vision system according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Also, terminologies used herein refer to terms used to appropriately represent the example embodiments and may vary based on a reader, the intent of an operator, or custom of a field to which this disclosure belongs, and the like. Accordingly, the definition of the terms should be made based on the overall description of the present specification.

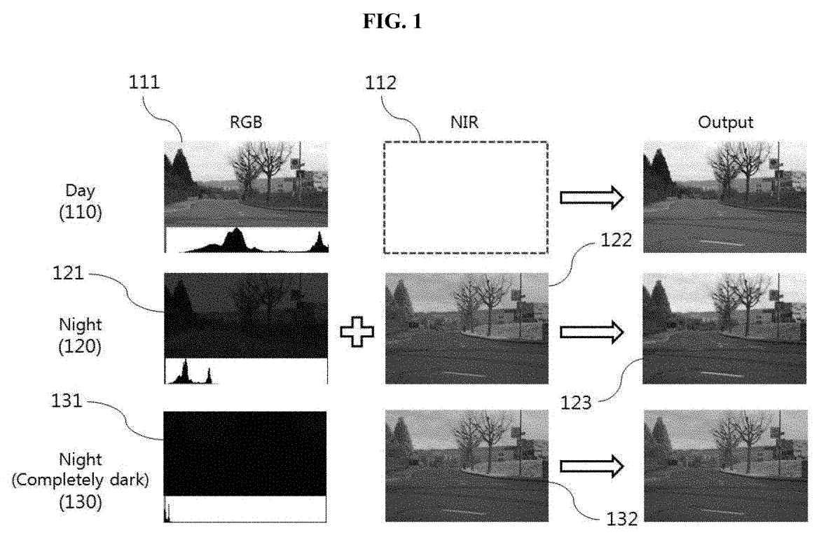

FIG. 1 illustrates an example of describing an operation method of a color night vision system according to an example embodiment.

Referring to FIG. 1, the color night vision system includes a single-4-color image sensor configured to acquire a red, green, blue (RGB) image, for example, RGB images 111, 121, and 131, and an infrared (IR) image, for example, IR images 112, 122, and 132, by processing RGB light signals and an IR light signal for each wavelength. The color night vision system uses the RGB image and the IR image between which a parallax is absent for a night vision image creation process of a processor, which is described blow.

The night vision image creation process performed at a processor included in the color night vision system refers to a process of selectively using at least one of the RGB image, for example, the RGB images 111, 121, and 131, the IR image, for example, the IR images 112, 122, and 132, or a synthetic image between the RGB image and the IR image as an output image, for example, a color night vision image, based on a luminance environment of the color night vision system. Hereinafter, the luminance environment indicates a presence situation of RGB light signals including a presence or an absence of RGB light signals in a space in which the color night vision system is located, a presence level difference, and the like.

In detail, the color night vision image creation process may include a process of outputting an RGB image as an output image during the day 110 or in an environment with a sufficient illumination, by outputting a synthetic image of the RGB image and the IR image as the output image in a low luminance environment 120 in which a portion of RGB light signals are present, or by outputting an IR image as the output image in a dark state 130 in which the RGB light signals are barely present.

For example, when the RGB image 111 and the IR image 112 are acquired from a single-4-color image sensor during the day 110 or the environment with the sufficient illumination, the processor may determine an exposure state of the RGB image 111 as a normal state by analyzing a brightness distribution of the RGB image 111, may decide all of an exposure compensation level of the RGB image 111, a denoising level of the RGB image 111, and a synthesis ratio between the RGB image 111 and the IR image 112 as null values, and may use the RGB image 111 as the output image without performing an exposure compensation and a denoising on the RGB image 111 or without synthesizing the RGB image 111 and the IR image 112.

Hereinafter, analyzing the brightness distribution of the RGB image 111, 121, 131 indicates a luminance distribution analysis using a brightness histogram of the RGB image 111, 121, 131. Also, analyzing the brightness distribution of the RGB image 111, 121, 131 indicates verifying an amount of information included in the RGB image 111, 121, 131 to create the output image by comparing and analyzing the brightness distribution of the RGB image 111, 121, 131 based on preset threshold values, and determining whether it is possible to compensate of an insufficient exposure

Also, analyzing the brightness distribution of the RGB image 111, 121, 131 may indicate comparing and analyzing the brightness distribution of the RGB image 111, 121, 131 based on the brightness distribution of the IR image 112, 122, 132. In this case, comparing and analyzing the brightness distribution of the RGB image 111, 121, 131 based on the brightness distribution of the IR image 112, 122, 132 indicates verifying an amount of information included in the RGB image 111, 121, 131 to create the output image by comparing the brightness distribution of the IR image 112, 122, 132 and the brightness distribution of the RGB image 111, 121, 131 and determining whether it is possible to compensate of an insufficient exposure.

Here, even during the day 110 or the environment with the sufficient illumination, when it is determined that the exposure state of the RGB image 111 is in an insufficient state and the exposure state of the RGB image 111 is recoverable through an exposure compensation, the processor may decide the exposure compensation level of the RGB image 111 as a predetermined value, may perform the exposure compensation on the RGB image 111 based on the decided value, and may use the exposure-compensated RGB image 111 as the output image.

Also, when performing a preprocessing process to be described below, the processor may use the exposure-compensated and denoised RGB image 111 as the output image since the exposure compensation and the denoising are performed on the RGB image 111.

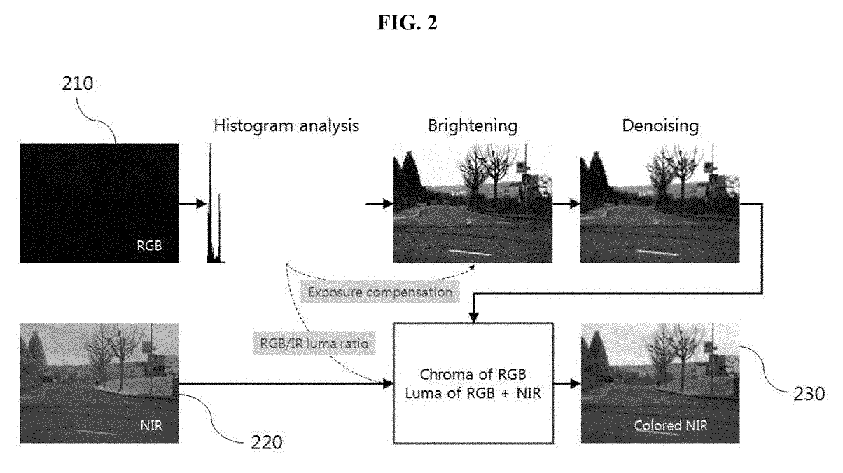

As another example, in the low luminance environment 120 in which a portion of RGB light signals are present, when the RGB image 121 and the IR image 122 are acquired from the single-4-color image sensor, the processor may analyze a brightness distribution of the RGB image 121 and may determine that an exposure state of the RGB image 121 is in an insufficient state and the exposure state of the RGB image 121 is irrecoverable through an exposure compensation. Here, when partial information for creating the output image remains in the RGB image 121 regardless of the exposure state of the RGB image 121 being irrecoverable through the exposure compensation, the processor may decide a synthesis ratio between the RGB image 121 and the IR image 122 as a predetermined value and may synthesize the RGB image 121 and the IR image 122 based on the decided value. Accordingly, the processor may use a synthetic image 123 of the RGB image 121 and the IR image 122 as the output image. A further description related thereto will be made with reference to FIG. 2.

As described above, the processor may create the output image, for example, the synthetic image 123, by adjusting the synthesis ratio between the RGB image 121 and the IR image 122, instead of creating the output image through denoising in the low luminance environment 120. In this manner, the sharpness of the output image may be guaranteed.

Here, the processor may decide a ratio among R image, G image, and B image in the RGB image 121 during the process of deciding the synthesis ratio between the RGB image 121 and the IR image 122.

As another example, in the dark state 130 in which RGB light signals are barely present, when the RGB image 131 and the IR image 132 are acquired from the single-4-color image sensor, the processor may analyze a brightness distribution of the RGB image 131 and may determine that an exposure state of the RGB image 131 is in an insufficient state and the exposure state of the RGB image 131 is in a dark state. Next, the processor may decide all of an exposure compensation level of the RGB image 131, a denoising level of the RGB image 131, and a synthesis ratio between the RGB image 131 and the IR image 132 as null values and may use the IR image 132 as the output image without performing the exposure compensation and the denoising on the RGB image 131 or without synthesizing the RGB image 131 and the IR image 132.

Also, when the exposure states of the RGB images 111, 121, and 131 are determined as the insufficient state in all of the day 110 or the environment with the sufficient illumination, the low luminance environment 120, and the dark state 130 in which the RGB light signals are barely present, the processor may perform preprocessing, such as the exposure compensation and the denoising, on the RGB images 111, 121, and 131, to correct a color contamination between the RGB light signals and the IR light signal using the single-4-color image sensor. In this case, similarly, the processor may decide the exposure compensation level and the denoising level based on a result of analyzing the brightness distribution of each of the RGB images 111, 121, 131 and may perform preprocessing, such as the exposure compensation and the denoising, on each of the RGB images 111, 121, and 131 based on the decided exposure compensation level and denoising level.

In the case of performing preprocessing in the low luminance environment 120 in which a portion of RGB light signals are present, the processor may decide the exposure compensation level and the denoising level of the RGB image 121 and the synthesis ratio between the RGB image 121 and the IR image 122 through mutual association.

FIG. 2 illustrates an example of describing an operation method of a color night vision system in a low luminance environment of FIG. 1 in which a portion of RGB light signals are present.

Referring to FIG. 2, in the low luminance environment in which a portion of RGB light signals are present, a processor included in the color night vision system according to an example embodiment may use a synthetic image 230 of an RGB image 210 and an IR image 220 as an output image.

In detail, when it is determined that an exposure state of the RGB image 210 is in an insufficient state, the exposure state of the RGB image 210 is irrecoverable through an exposure compensation, and partial information for creating the output image remains in the RGB image 210 as a result of analyzing a brightness distribution of the RGB image 210 in the low luminance environment in which a portion of RGB light signals are present, the processor may output the synthetic image 230 by deciding a synthesis ratio between the RGB image 210 and the IR image 220 as a predetermined value based on the determination result and by synthesizing the RGB image 210 and the IR image 220 based on the decided value.

During the synthesis process of the RGB image 210 and the IR image 220, the processor may synthesize the RGB image 210 and the IR image 220 by deciding the synthesis ratio between the RGB image 210 and the IR image 220 as a predetermined value, by converting a color space of the RGB image 210 to YCbCr, and by weighted-averaging a converted luminance component and the IR image 220 based on the decided synthesis ratio.

Here, the processor may decide the synthesis ratio between the RGB image 210 and the IR image 220 as a predetermined value based on a luminance environment of the color night vision system to minimize noise in the synthetic image 230, and also may decide the synthesis ratio between the RGB image 210 and the IR image 220 as a predetermined value so that a color of the synthetic image 230 may appear natural in order to guarantee the quality of the synthetic image 230. In the case of synthesizing the RGB image 210 and the IR image 220, a difference between the color of the synthetic image 230 and a color of the original RGB image 210 increases according to an increase in a ratio of the IR image 220. On the other hand, according to an increase in a ratio of the exposure-compensated and denoised RGB image 210, the sharpness of the synthetic image 230 decreases. Since a low band pass filter is used during the exposure compensation and denoising process, the sharpness of an exposure-compensated image decreases according to an increase in an exposure insufficiency. Accordingly, to maintain the sharpness of the synthetic image 230 and to maintain a color difference with the original RGB image 210, the ratio of the RGB image 210 may be decreased according to an increase in an exposure insufficiency level of the RGB image 210.

That is, in the luminance environment of the color night vision system, the processor may increase a synthesis ratio of the IR image 220, that is, decrease a synthesis ratio of the RGB image 210, in the synthetic image 230 according to a decrease in the number of RGB light signals, and conversely, may increase the synthesis ratio of the RGB image 210, that is, decrease the synthesis ratio of the IR image 220, in the synthetic image 230 according to an increase in the number of RGB light signals.

Also, if necessary, the processor may perform the exposure compensation and the denoising on the RGB image 210. In this case, the processor may additionally decide an exposure compensation level and a denoising level of the RGB image 210 during the process of deciding the synthesis ratio between the RGB image 210 and the IR image 220 as a result of analyzing the brightness distribution of the RGB image 210, and may perform the exposure compensation and the denoising on the RGB image 210 based on the decided exposure compensation level and denoising level.

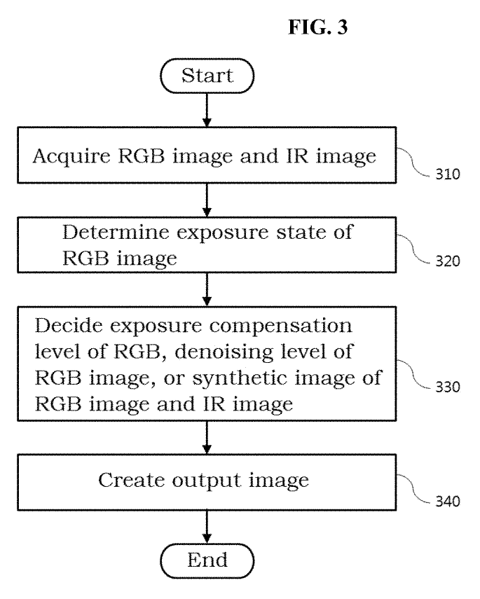

FIG. 3 is a flowchart illustrating an operation method of a color night vision system according to an example embodiment.

Referring to FIG. 3, in operation 310, the color night vision system according to an example embodiment acquires an RGB image and an IR image by processing RGB light signals and an IR light signal for each wavelength using a single-4-color image sensor.

In operation 320, the color night vision system determines an exposure state of the RGB image by analyzing a brightness distribution of the RGB image using a processor.

Here, operation 320 may include a luminance distribution analysis using a brightness histogram of the RGB image.

Also, operation 320 may include an operation of comparing and analyzing the brightness distribution of the RGB image based on preset threshold values and verifying an amount of information included in the RGB image to create the output image and an operation of determining and analyzing whether insufficient information is recoverable.

Also, operation 320 may include an operation of comparing and analyzing the brightness distribution of the RGB image based on a brightness distribution of the IR image. In this case, the processor may perform an operation of additionally acquiring the brightness distribution of the IR image. Operation 320 may include an operation of comparing the brightness distribution of the IR image and the brightness distribution of the RGB image and verifying an amount of information included in the RGB image to create the output image, and an operation of determining and analyzing whether insufficient information is recoverable.

In operation 330, the color night vision system decides at least one of an exposure compensation level of the RGB image, a denoising level of the RGB image, or a synthesis ratio between the RGB image and the IR image based on the determination result, using the processor.

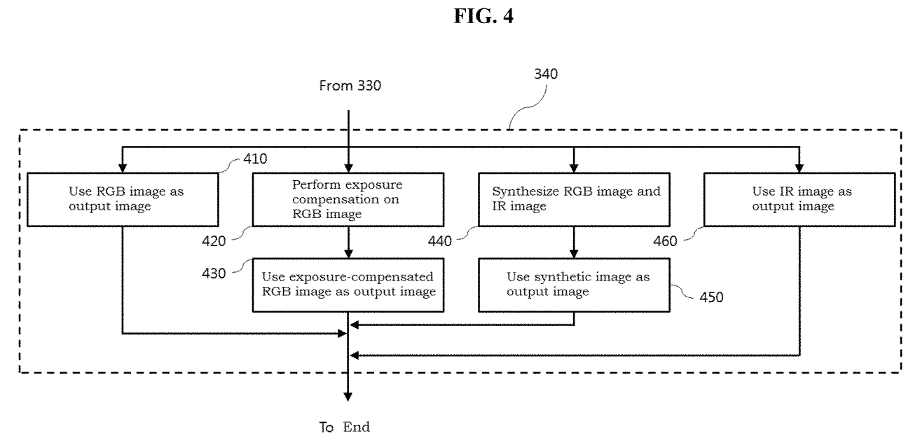

In operation 340, the color night vision system creates an output image based on the decision result that is made using the RGB image and the IR image, using the processor. In detail, in operation 340, the processor may selectively use at least one of the RGB image, the IR image, or the synthetic image of the RGB image and the IR image as the output image based on the decision result. A further description related thereto will be made with reference to FIG. 4.

FIG. 4 is a flowchart illustrating an operation of creating an output image of FIG. 3.

Referring to FIG. 4, when the exposure state of the RGB image is determined as a normal state in operation 320 of FIG. 3, the processor included in the color night vision system may use the RGB image as is as the output image in operation 410.

On the contrary, when it is determined that the exposure state of the RGB image is in an insufficient state and the exposure state of the RGB image is recoverable through an exposure compensation in operation 320 of FIG. 3, the processor may perform the exposure compensation on the RGB image based on the exposure compensation level decided in operation 330, in operation 420, and may use the exposure-compensated RGB image as the output image in operation 430.

Also, when it is determined that the exposure state of the RGB image is in the insufficient state, the exposure state of the RGB image is irrecoverable through the exposure compensation, and partial information for creating the output image remains in the RGB image in operation 320 of FIG. 3, the processor may synthesize the RGB image and the IR image based on the synthesis ratio decided in operation 330, in operation 440, and may use the synthetic image as the output image in operation 450.

Here, in operation 440, the processor may synthesize the RGB image and the IR image by weighted-averaging the RGB image and the IR image based on the decided synthesis ratio.

Also, when it is determined that the exposure state of the RGB image is in the insufficient state and the exposure state of the entire area of the RGB image is in a dark state, the processor may use the IR image as is as the output image in operation 460.

Also, although not illustrated, the processor may perform preprocessing including the exposure compensation and the denoising on the RGB image when the RGB image is acquired in a low luminance environment, that is, when the exposure state of the RGB image is determined as the insufficient state. In this case, the processor may perform preprocessing based on the exposure compensation level and the denoising level decided in operation 330 of FIG. 3. In particular, when it is determined that the exposure state of the RGB image is in the insufficient state, the exposure state of the RGB image is irrecoverable using only the exposure compensation, and partial information for creating the output image remains in the RGB image, the aforementioned preprocessing process may be performed before synthesizing the RGB image and the IR image.

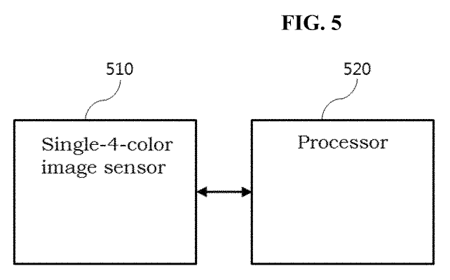

FIG. 5 is a block diagram illustrating a color night vision system according to an example embodiment.

Referring to FIG. 5, the color night vision system includes a single-4-color image sensor 510 and a processor 520.

The single-4-color image sensor 510 acquires an RGB image and an IR image by processing RGB light signals and an IR light signal for each wavelength.

The processor 520 determines an exposure state of the RGB image by analyzing a brightness distribution of the RGB image, decides at least one of an exposure compensation level of the RGB image, a denoising level of the RGB image, or a synthesis ratio between the RGB image and the IR image based on the determination result, and creates an output image based on the decision result that is made using the RGB image and the IR image.

Here, analyzing the brightness distribution of the RGB image may include a luminance distribution analysis using a brightness histogram of the RGB image.

Also, analyzing the brightness distribution of the RGB image may include a process of comparing and analyzing the brightness distribution of the RGB image based on preset threshold values and verifying an amount of information included in the RGB image to create the output image and a process of determining and analyzing whether insufficient information is recoverable.

Also, analyzing the brightness distribution of the RGB image may include a process of comparing and analyzing the brightness distribution of the RGB image based on a brightness distribution of the IR image. In this case, the processor 520 may additionally acquire the brightness distribution of the IR image. Analyzing the brightness distribution of the RGB image may include a process of comparing the brightness distribution of the IR image and the brightness distribution of the RGB image and verifying an amount of information included in the RGB image to create the output image and a process of determining and analyzing whether insufficient information is recoverable.

In detail, the processor 520 may selectively use at least one of the RGB image, the IR image, or the synthetic image of the RGB image and the IR image as the output image based on the decision result.

For example, when the exposure state of the RGB image is determined as a normal state, the processor 520 may use the RGB image as is as the output image.

As another example, when it is determined that the exposure state of the RGB image is in the insufficient state and the exposure state of the RGB image is recoverable through an exposure compensation, the processor 520 may perform the exposure compensation on the RGB image based on the decided exposure compensation level, and may use the exposure-compensated output RGB image as the output image.

As another example, when it is determined that the exposure state of the RGB image is in the insufficient state, the exposure state of the RGB image is irrecoverable through the exposure compensation, and partial information for creating the output image remains in the RGB image, the processor 520 may synthesize the RGB image and the IR image based on the decided synthesis ratio and may use the synthetic image acquired from the synthesizing. In this case, the processor 520 may synthesize the RGB image and the IR image by weighted-averaging the RGB image and the IR image based on the decided synthesis ratio.

As another example, when the exposure state of the RGB image is determined as a dark state, the processor 520 may use the IR image as is as the output image.

Also, when the RGB image is acquired in a low luminance environment, that is, when the exposure state of the RGB image is determined as the insufficient state, the processor 520 may perform preprocessing including the exposure compensation and denoising on the RGB image. In this case, the processor 520 may perform preprocessing based on the decided exposure compensation level and denoising level. In particular, when it is determined that the exposure state of the RGB image is in the insufficient state, the exposure state of the RGB image is irrecoverable, and partial information still remains in the RGB image, the aforementioned preprocessing process may be performed before synthesizing the RGB image and the IR image.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A color night vision system comprising:
a single-4-color image sensor configured to acquire a red, green, blue (RGB) image and an infrared (IR) image by processing RGB light signals and an IR light signal for each wavelength; and
a processor configured to determine an exposure state of the RGB image by analyzing a brightness distribution of the RGB image, to decide at least one of an exposure compensation level of the RGB image, a denoising level of the RGB image, or a synthesis ratio between the RGB image and the IR image based on the determination result, and to create an output image based on the decision result that is made using the RGB image and the IR image.

2. The color night vision system of claim 1, wherein the processor is configured to selectively use at least one of the RGB image, the IR image, or a synthetic image of the RGB image and the IR image as the output image.

3. The color night vision system of claim 2, wherein the processor is configured to use the RGB image as the output image in response to the exposure state of the RGB image being determined as a normal state.

4. The color night vision system of claim 2, wherein the processor is configured to perform an exposure compensation on the RGB image based on the decided exposure compensation level in response to the exposure state of the RGB image being determined as an insufficient state and the exposure state of the RGB image being recoverable through an exposure compensation, and to use the exposure-compensated RGB image as the output image.

5. The color night vision system of claim 2, wherein the processor is configured to synthesize the RGB image and the IR image based on the decided synthesis ratio in response to the exposure state of the RGB image being determined as an insufficient state, the exposure state of the RGB image being irrecoverable through an exposure compensation, and partial information for creating the output image remaining in the RGB image, and to use the synthetic image acquired through the synthesis as the output image.

6. The color night vision system of claim 5, wherein the processor is configured to synthesize the RGB image and the IR image by weighted-averaging the RGB image and the IR image based on the decided synthesis ratio.

7. The color night vision system of claim 2, wherein the processor is configured to use the IR image as the output image in response to the exposure state of the RGB image being determined as a dark state.

8. The color night vision system of claim 1, wherein the processor is configured to perform an exposure compensation and a denoising on the RGB image in response to the RGB image being acquired from the single-4-color image sensor in a low luminance environment.

9. An operation method of a color night vision system, the method comprising:
acquiring, using a single-4-color image sensor, a red, green, blue (RGB) image and an infrared (IR) image by processing RGB light signals and an IR light signal for each wavelength;
determining, using a processor, an exposure state of the RGB image by analyzing a brightness distribution of the RGB image;
deciding, using the processor, at least one of an exposure compensation level of the RGB image, a denoising level of the RGB image, or a synthesis ratio between the RGB image and the IR image based on the determination result; and
creating, using the processor, an output image based on the decision result that is made using the RGB image and the IR image.

10. The method of claim 1, wherein the creating of the output image comprises selectively using at least one of the RGB image, the IR image, or a synthetic image of the RGB image and the IR image as the output image.

11. The method of claim 10, wherein the selectively using comprises using the RGB image as the output image in response to the exposure state of the RGB image being determined as a normal state.

12. The method of claim 10, wherein the selectively using comprises:
performing an exposure compensation on the RGB image based on the decided exposure compensation level in response to the exposure state of the RGB image being determined as an insufficient state and the exposure state of the RGB image being recoverable through an exposure compensation; and
using the exposure-compensated RGB image as the output image.

13. The method of claim 10, wherein the selectively using comprises:
synthesizing the RGB image and the IR image based on the decided synthesis ratio in response to the exposure state of the RGB image being determined as an insufficient state, the exposure state of the RGB image being irrecoverable through an exposure compensation, and partial information for creating the output image remaining in the RGB image; and
using the synthetic image acquired through the synthesis as the output image.

14. The method of claim 10, wherein the selectively using comprises using the IR image as the output image in response to the exposure state of the RGB image being determined as a dark state.

15. A non-transitory computer-readable medium storing computer-readable instructions to cause a computer system to implement an operation method of a color night vision system in conjunction with an electronic device, wherein the computer-readable instructions control the computer system to implement the operation method of the color night vision system, the method comprising:
acquiring, using a single-4-color image sensor, a red, green, blue (RGB) image and an infrared (IR) image by processing RGB light signals and an IR light signal for each wavelength;
determining, using a processor, an exposure state of the RGB image by analyzing a brightness distribution of the RGB image;
deciding, using the processor, at least one of an exposure compensation level of the RGB image, a denoising level of the RGB image, or a synthesis ratio between the RGB image and the IR image based on the determination result; and
creating, using the processor, an output image based on the decision result that is made using the RGB image and the IR image.
